(19) United States
(12) Patent Application Publication
(10) Pub. No.: US 2018/0218465 A1
(43) Pub. Date: Aug. 2, 2018

(54) Service To Identify Class Action Settlements For Which A User Is A Class Member And Assist The User In Obtaining Settlement Damages

(71) Applicant: Ryan Calder Lenea, Shoreline, WA (US)

(72) Inventor: Ryan Calder Lenea, Shoreline, WA (US)

(21) Appl. No.: 15/935,032

(22) Filed: Mar. 25, 2018

Related U.S. Application Data
(60) Provisional application No. 62/541,048, filed on Aug. 3, 2017.

(51) Int. Cl. G06Q 50/18; G06Q 20/14; G06N 7/00

(52) U.S. Cl. CPC G06Q 50/18; G06N 7/005; G06Q 20/14

(57) ABSTRACT

A service to assist users in obtaining class-action lawsuit settlement damages to which they are entitled is disclosed. In some embodiments, user accounts are periodically accessed and purchase data identified and compared to settlement damages eligibility data to determine user eligibility for one or more settlement damages. For all settlements for which the service determines the user is a class member, one or more requisite settlement damages-claims are submitted by the service, with the user's information, to the appropriate Settlement Administrator, on behalf of the user.

### CROSS-REFERENCE TO RELATED APPLICATIONS

This invention claims benefit to U.S. Provisional Patent Application No. 62/541,048 filed on Aug. 8, 2017, which is hereby incorporated by reference for all purposes.

### BACKGROUND OF THE INVENTION

A “class action lawsuit,” or “representative action lawsuit” is a type of lawsuit filed by one or more plaintiffs on behalf of a larger group of similarly situated individuals and entities, who are referred to as a “class.” Such lawsuits are especially common when the extent of the harm experienced by each member of the class (hereinafter “class member”), is too limited to warrant bringing an individual lawsuit.

Unfortunately, class members who are included in successful class action lawsuits often never receive the compensation (hereinafter, “settlement-damages”) to which they are entitled.

In the large majority of cases, the amount of each class member's claim cannot be exactly anticipated, meaning distribution of settlement-damages must be done on a claims-made basis in which only the small percentage of those who file claims are paid.

A study by Mayer Brown LLP entitled “Do Class Actions Benefit Class Members?” that examined class action lawsuits filed or removed to federal courts in 2009, found that in a sample, settlement-damages were distributed on a claims-made basis 97.5 percent of the time; yet, in a sample of claims-made settlements, only 4.6 percent of class members submitted claims.

Other studies have corroborated both the commonality of claims-made distribution, and the infrequency with which claims are filed by class members (see Mayer Brown study appendix A and references).

The rarity of claim filing can largely be explained by the fact that the parties in settled class-action lawsuits often do not have a means of contacting individual class members directly and instead rely upon general advertising campaigns which may be substantially underfunded and poorly targeted, and, as a result, may not actually reach most of the class members.

Moreover, in cases where class members' contact information is known, not all attempts to convey eligibility information will be successful. A language barrier may hinder communication, for example, or a notice may be mistaken for a solicitation and discarded.

Currently, the only alternative to relying on Settlement Administrators to effectively communicate with class members is to regularly look through settlements oneself, a time-consuming endeavor given the large number of open settlements at any given time.

Even when class members learn of their eligibility for a settlement, they may not consider it worth the effort to file a claim. Doing so is a tedious process which often involves producing month-old or even year-old receipts and completing a multiple-page application, sometimes for only a couple of dollars in settlement-damages.

US Patent Application Publication 2016/0104188 of Eric Robert et al. published Apr. 14, 2016 with the title “Consumer Price Protection Service” is incorporated herein by reference. This document describes a system wherein prices, rebates and/or coupons may be monitored with respect to goods and/or services purchased by consumers. When applicable, store policies for price adjustments, rebates, and/or coupons may be saved, and websites may be searched for these price adjustments, rebates, and/or coupons. When a price adjustment, rebate, and/or coupon is found for a product or service purchased by a consumer, the system may automatically submit a claim for the price adjustment, rebate, and/or coupon. When the money is received by the consumer, the company offering the consumer monitoring service may charge the consumer a portion thereof.

U.S. Pat. No. 8,442,895 to Hamer, et al., issued May 14, 2013 with the title “Report generator for allowing a financial entity to monitor securities class action lawsuits and potential monetary claims resulting therefrom and including loss chart selection” is incorporated herein by reference. This document describes a method and apparatus whereby Reports are automatically created of securities class action lawsuits customized to show potential monetary claims resulting from the lawsuits for securities purchased or acquired by one or more financial entities. Further, a database stores more loss charts. Each loss chart is related to a particular security for a particular financial entity and is assigned a unique identifier. The report includes a selection process, such as the selection of a hyperlink on the report, that allows a user to input the unique identifier to the loss chart directly from the report so that the loss chart can be retrieved from the database and presented to the user. More sets of loss charts are provided wherein each set of loss charts is related to a particular security for a particular financial entity. Each set of loss charts includes a Summary Chart and a FIFO and LIFO loss chart.

U.S. Pat. No. 8,272,052 to Zola et al. issued Sep. 18, 2012 with the title “Method and System for Filing and Monitoring Electronic Claim Submissions in Multi-Claimant Lawsuits” is incorporated herein by reference. This document describes a method and system whereby reports are automatically created that allow a financial entity to review and track potential monetary claims resulting from securities class action lawsuits for securities purchased or acquired by the financial entity. To create the reports, a first database of transaction activity for the financial entity is accessed. The transaction activity includes an identification of each security purchased or acquired, and the date of each purchase or acquisition. A second database of securities class action lawsuits is accessed. The second database includes for each lawsuit an identification of all securities associated with the class action lawsuit, and the class period of the lawsuit. The transaction activity of the financial entity is automatically compared with the securities class action lawsuits in the second database, and any securities purchased or acquired by the financial entity during the class period that are associated with an entered securities class action lawsuit are identified. The identified securities may provide a potential monetary claim for the financial entity. A report is then automatically created of at least the lawsuits that may provide a potential monetary claim for the financial entity based on the transaction activity of the financial entity. The report also includes estimated market loss and eligible loss information, as well as any actions recommended to be taken by the financial entity regarding the lawsuits.

US Patent Application Publication 2007/0214095 of Kenneth L. Adams et al. published Sep. 13, 2007 with the title “Monitoring and notification system and method” is incorporated herein by reference. This document describes an invention providing a method and system for monitoring sources meeting predetermined criteria and providing a user the data meeting the criteria. The method and system are particularly suited for monitoring sources potentially containing information related to class actions and providing the user with data related to class actions.

### SUMMARY OF THE INVENTION

In one embodiment, user purchase data is periodically accessed and referenced with compensatory settlement-damages eligibility information to determine that an individual enrolled in the service (hereinafter, “a user”) is entitled to, or is likely entitled to, one or more settlement-damages. When the service can identify all the information necessary to both determine that a user is eligible for settlement-damages and complete the corresponding settlement-damages claim, the settlement-damages claim is submitted on behalf of the user. When additional information is needed to make an eligibility determination or to complete a claim, additional information is requested from the user. The user is charged a fee for the service.

This and other embodiments of the invention are described in further detail below.

### SUMMARY OF THE DRAWINGS

FIGS. 1 through 3 are architectural diagrams according to various embodiments of the invention.

FIGS. 4 and 5 are architectural diagrams illustrating how records may be created in user accounts.

FIGS. 6 through 12 are flowcharts illustrating various embodiments of the invention.

FIG. 13 is a self-explanatory ER diagram of a database of the service in one embodiment of the invention.

FIGS. 14A and 14B illustrate a database of the service in one embodiment of the invention.

### DETAILED DESCRIPTION OF THE INVENTION

Although the following detailed description contains many specifics for the purposes of illustration, a person skilled in the art will appreciate that many variations and alterations to the following details are within the scope of the invention. Accordingly, the following preferred embodiments of the invention are set forth without any loss of generality to, and without imposing limitations upon, the claimed invention.

In the following detailed description of the preferred embodiments, reference is made to the accompanying drawings that form a part hereof, and in which are shown by way of illustration specific embodiments in which the invention may be practiced. It is understood that other embodiments may be utilized, and structural changes may be made without departing from the scope of the present invention.

The leading digit(s) of reference numbers appearing in the Figures generally corresponds to the figure number in which that component is first introduced, such that the same reference number is used throughout to refer to an identical component which appears in multiple Figures.

The service addresses the problem of class members in class-action-settlements not receiving the settlement-damages to which they are entitled. Settlement-damages are often not automatically distributed, and searching for settlement-damages for which one qualifies is a tedious and time-consuming endeavor. Depending on the embodiment, the invention provides partial or full automation of the process of identifying relevant settlement opportunities and submitting settlement-damages claims.

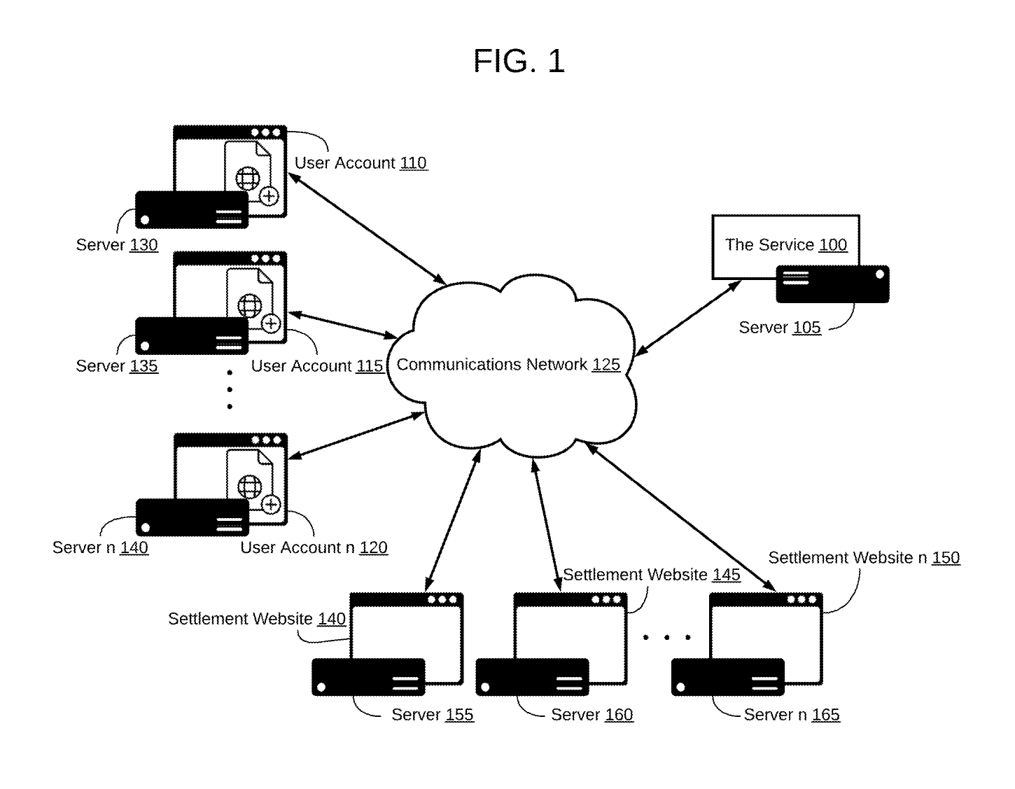

FIG. 1 is an architectural diagram of one embodiment of the service in which the service 100, employing data stored on a server 105, periodically logs into user accounts (e.g., email, bank, brokerage, accounts associated with cellular phone plans) 110, 115, through n 120, using users' account credentials, by communicating through a communications network 125 (e.g., the internet), with the servers containing the user account data 130, 135, through n 140, and data on user purchases or phone records (hereinafter “user purchase data”) is collected. The service identifies settlement-damages for which users are eligible, and submits one or more relevant settlement-damages claims to one or more relevant Settlement Administrators, on behalf of each user. In this case the settlement-damages-claims are submitted via the settlements' websites 140, 145 through n 150, by communicating through a communications network 125 (e.g., the internet) with the servers containing the settlement websites' data 155, 160 through n 165. However, the claims may also be submitted to the Settlement Administrators via a mail delivery service (e.g. United States Postal Service™, UPS™, FedEx™), via email, or by any other allowable means.

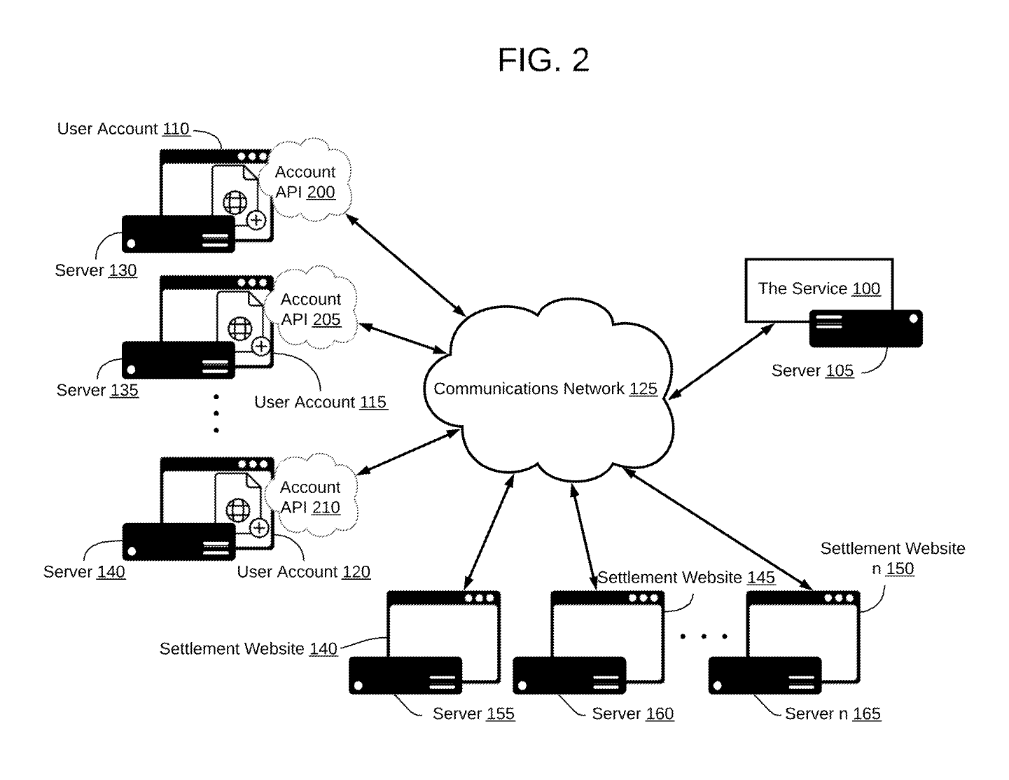

FIG. 2 is an architectural diagram of another embodiment, in which the service utilizes reverse engineered Application Programing Interfaces (APIs) 200, 210, through 215 [], stored on the same servers 130, 135, through n 140, to gather purchase information stored in user accounts.

In other embodiments, the invention is incorporated into the scope of an existing entity, which may include but is not limited to: banks, brokerages, non-for-profit organizations, online payment services (e.g., Paypal™, Venmo™, BitPay™), credit card issuers (e.g., Visa™, MasterCard™), telephony related services or companies (e.g., Sprint™, US Mobile™, Google™ Voice™), personal financial management companies (e.g., Mint™, Personal Capital™), or any combination thereof.

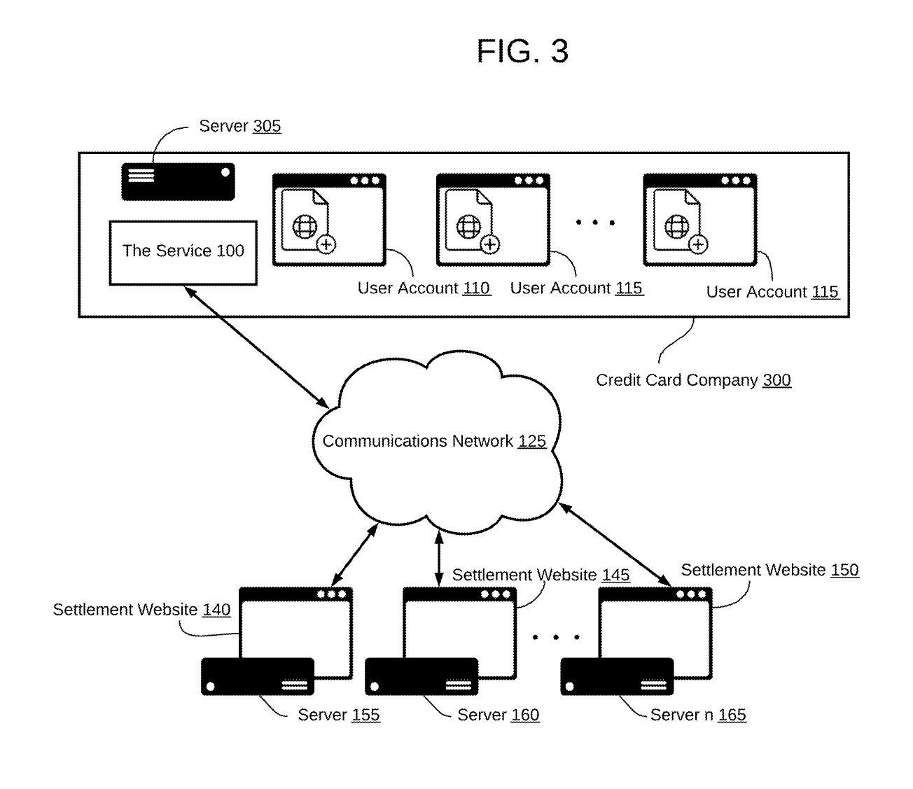

For example, a credit card issuer might offer a service or feature of identifying settlement-damages for which a customer of the credit card service is eligible, using the customer's credit card purchase data, and subsequently submitting a damages-claim on behalf of the customer. FIG. 3 is an architectural diagram illustrating such an embodiment.

Initially, an entity, in this case a credit card company 300, deploys the service which employs data on the server 305, to collect customer purchase data stored by the company on the same server 305. The service uses a “back door” method available to those with account administrative privileges to access the accounts.

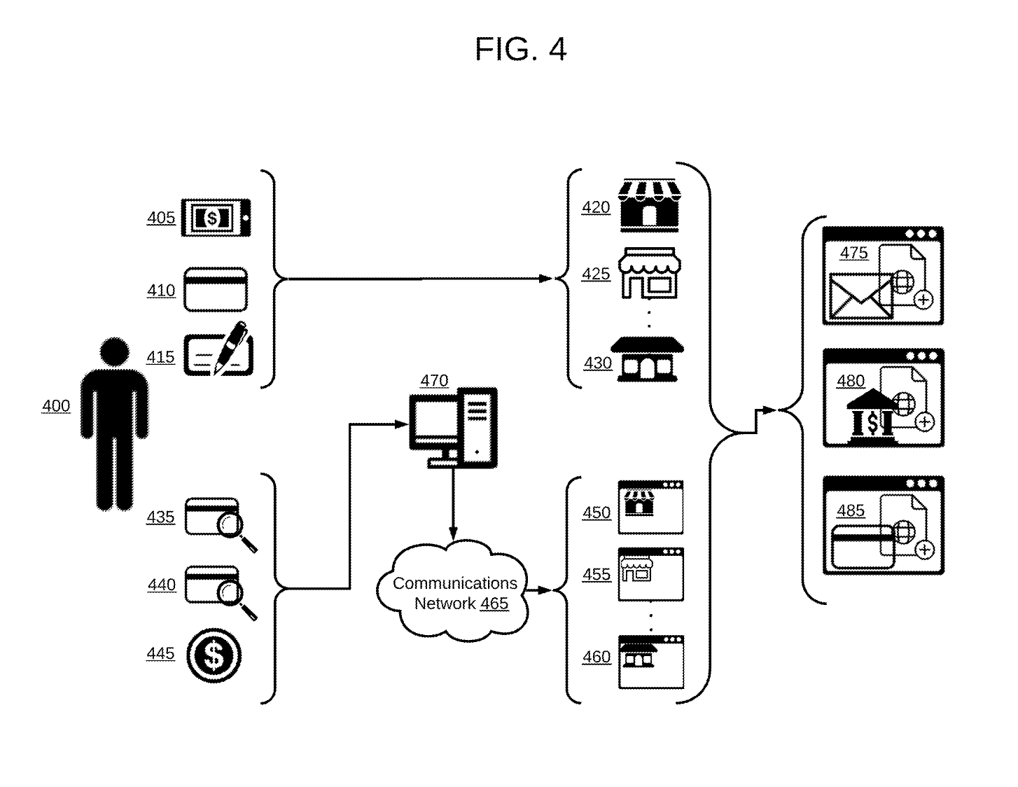

FIG. 4 is an architectural diagram illustrating multiple ways in which purchase records may be created in a user account. A user 400 uses a mobile payment service on a smartphone 405, a credit card 410, and checks 415, to make purchases in person from retailers or service providers 420, 425, through n 430. The user also uses credit card information 435, debit card information 440, and an online payment service 445, to make purchases from online retailers and service providers 450, 455, through n 460, by connecting to a communications network 465 (e.g. the internet), via a personal device, in this case a personal computer 470.

However, the user may also use any other means of payment that results in the creation of purchase records in one or more user accounts, without deviating from the scope of the invention. In this case, the user's purchases result in the creation of purchase records in three accounts: an email account 475, a bank account 480, and a credit card issuer account 485. However, records of purchases could be created in an alternate number of accounts and different types of accounts that might contain purchase data, without deviating from the scope of the invention.

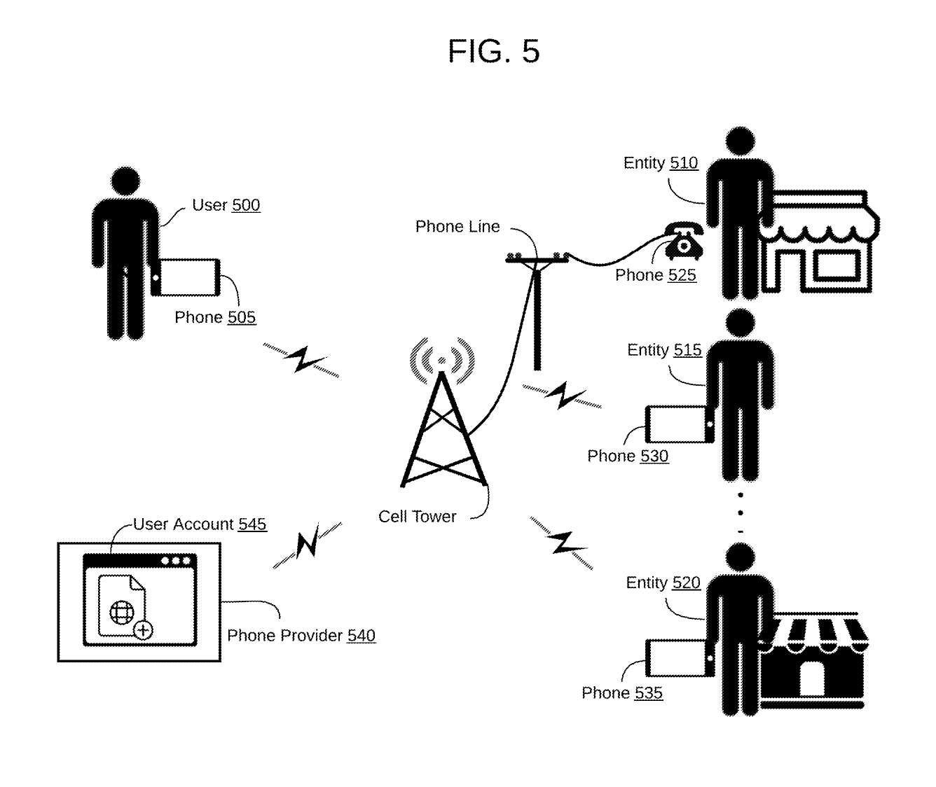

FIG. 5 is an architectural diagram illustrating an additional way records may be created in a user account. A user 500 uses a phone 505 to make and receive calls, texts messages, and voicemail messages (hereinafter “phone communications”) with entities 510, 515 through n 520, who send and receive phone communications on phones 525, 530, through n 535. While in this case all phone communications are two sided, the user might also receive phone communications from entities with which she does not communicate, and send phone communications to entities which do not communicate back. Data about a user's sent and received phone communications are collected and stored by the user's phone network or virtual network provider 540 (e.g., Sprint, US Mobil), some or all of which may be made available to the user in the user's account 545 with the provider.

While FIG. 1 through FIG. 5 depict single servers for viewing simplicity, any of the referenced accounts, websites, and the service may be stored on multiple servers.

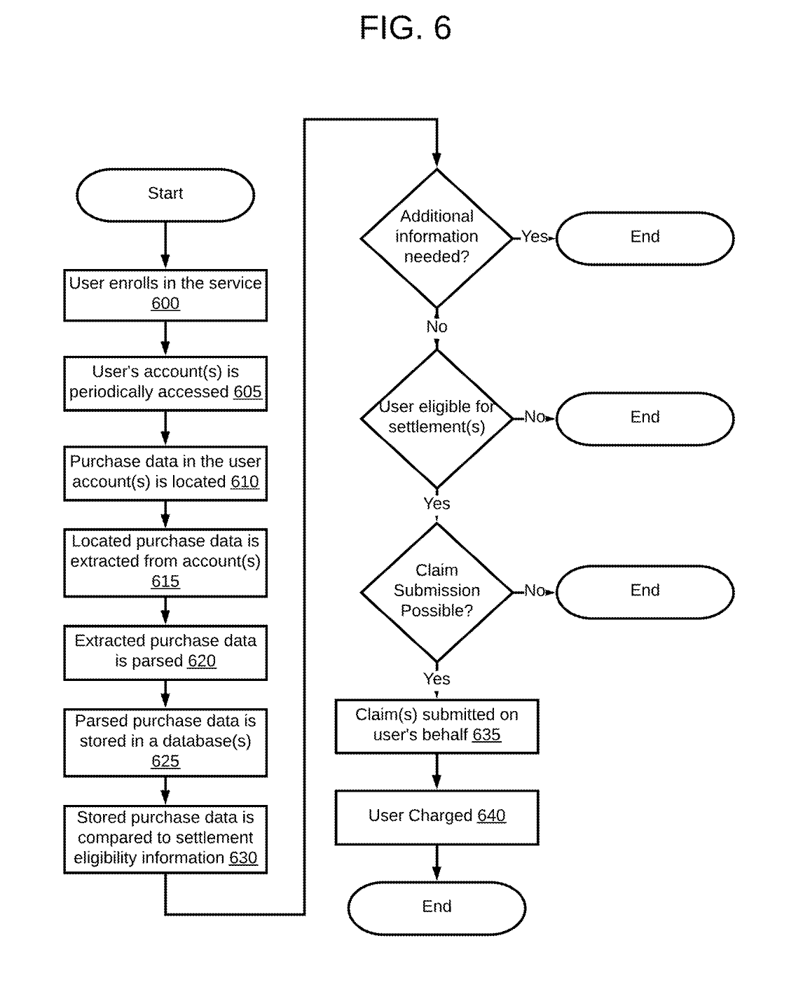

FIG. 6 is a flowchart of one embodiment of the invention. The user enrolls in the service at 600.

In some embodiments, upon enrollment, a user power-of-attorney document(POA) is collected from the user. The POA may name an employee of the service as an agent of the user with authority to complete and submit claims on the user's behalf or may name multiple employees of the service, or a certain kind of employee of the service (e.g., all employees who manage claim submissions). Alternatively, the user may complete and return the POA at some time after enrollment (e.g., at the time the first opportunity for settlement-damages arises). A remote notary service (e.g., NotaryCam™, Notorize.com™) may be used to facilitate the notarization of POAs. In some embodiments, the scope of the service does not include submitting claims on a user's behalf, and a POA is not collected.

In embodiments where the service does not already have access to a user account, or multiple user accounts, upon enrollment the service collects user account credentials. In some embodiments, the service collects credentials for multiple types of accounts, while in other embodiments credentials for only one type are collected (e.g., the service might only support Amazon™ accounts). Account types for which credentials may be collected include, but are not limited to: email accounts, bank accounts, credit union accounts, online payment service (e.g., Paypal™, BitCoin™, Venmo™) accounts, brokerage accounts, credit card issuer (e.g., Visa™, MasterCard™) accounts, and telephony related services or companies (e.g., Sprint™, US Mobile™, Google Voice™) accounts, personal financial management companies (e.g., Mint™, Personal Capital™), or any combination thereof. Importantly, a user may have more than one account of a certain type and provide credentials for each.

Additionally, upon enrollment, the service also collects personal information, which may include, but is not limited to, the user's: full name, mailing address, home address, email address, phone number, and current and former employer and job title. One or more payment methods may also be provided by the user, although in some embodiments a payment method is collected later (e.g., after a settlement-claim is submitted on behalf of the user), or in embodiments in which a payment method is already on file, not collected at all.

Additionally, upon enrollment, the user is assigned a unique user ID, and each account collected from the user to be used by the service is assigned a unique account ID.

All information collected from the user is stored in one or more databases.

In some embodiments in which the service is integrated into another entity, user enrollment in the service may happen at the time the user enrolls in or establishes a relationship with the entity into which the service is integrated. For example, a bank might enroll a new customer in the service at the time the customer opened an account with the bank.

Following enrollment, one or more user accounts, depending on the embodiment and on how many accounts the user elected to provide the service access to, are periodically accessed 605.

Next, purchase data within the account is located, at 610. The account information may be located by following a URL previously saved by the service to a user account page containing user purchase information and submitting the user's account credentials to gain access to the account. Subsequently, the service may navigate through the website using Xpath, CSS selectors, Name, Class, ID, or any identifying information, to identify buttons, links, and text in the account. Time or date stamps or information included with purchase information in a user account may be used as reference points to determine what purchase data is new as of the last time the account was accessed by the service.

Locating purchase information in an email account, specifically, may be performed by searching for emails sent from email addresses known to be associated with specific service providers, retailers, banks, credit unions, brokerages, vendors, credit card companies, online payment services, or other companies which relay user purchase information (“sellers”), using one or more search functions, either native to the email application or externally implemented. For example, an email with the address <auto-confirm@amazon.com>might be used to identify emails from Amazon™. The service may determine that an email is from a seller by searching for certain: structural elements, words, phrases, symbols or any combination thereof, contained in an email. Emails opened by the service may be marked “not read” if the user has not yet viewed the email.

Moreover, in any type of account, the service may login using the user's same web browser, browser settings, cookies, or a server in the vicinity of the user, or any combination thereof, in order to avoid locking the account or triggering warnings messages. User account settings may be adjusted for the same purpose.

In some embodiments, APIs are employed and may be reverse engineered to better facilitate data extraction. Services that provide many APIs (aggregation APIs) such as Envestnet™, Yodlee™, and eWise™, may be utilized.

In some embodiments, a proxy server is used to “sit in the middle between” a merchant or service provider account belonging to the user, and the user email account, to intercept new communications.

Purchase data located in a user account is extracted at 615. Importantly, written as code, the first process of locating purchase data and second process of extracting purchase data, as illustrated in FIG. 5, may be indistinguishable in some of the embodiments described in the above paragraphs. However, the processes of locating purchase data and extracting purchase data are treated herein as discrete steps for clarity.

In some embodiments a receipt, invoice, order confirmation, or other manifestation of purchase data from which purchase data is collected, is graphically captured, and associated with the collected purchase data. Graphical capture of a user account may be performed by taking a screen shot of the account's graphical interface; sometimes, it may not be possible to take a screenshot, and a different method to graphically capture purchase data may be used. Of note, because data on individual purchases is often stored collectively (e.g., an itemized receipt containing multiple purchased items), each graphical capture of a manifestation of purchase information (hereinafter “Purchase Image”), may be associated with more than one individual purchase.

Extracted purchase data is parsed at 620. Parsing entails programmatically dividing the purchase data into individual product or service purchases, and, for each purchase, attempting to identify key information and assigning each purchase a unique purchase ID.

An iterative process of extracting and parsing data may be employed, in which data on one purchase is extracted and parsed before data on another purchase is extracted and parsed, etc. In cases in which user purchase data is not all contained in one location, or where purchase details are not visible without expanding a window, such an iterative process may be employed. For example, in an email account, an email might be identified as relating to a purchase, the purchase data extracted and parsed, another email identified, etc.

The parsed purchase data is subsequently stored in one or more databases of the service 625.

In some embodiments, location data from a user device (e.g., a phone) is accessed by the service and used to help determine settlement-damages eligibility. For example, it would be likely that a user who spent 45 minutes at the location of a restaurant which was the subject of a settlement related to a salmonella outbreak from the restaurant's food, and did so during the qualifying period for the settlement, would be eligible for settlement-damages. Because of the accuracy limitations of current GPS technology, it may be difficult to pinpoint a user's exact location, and a user's more specific location may be inferred by considering the user's general vicinity along with one or more of the usual destinations for someone in that vicinity. For instance, it might be inferred that a user who was near a store that was the only store in the area, was in, or had been in, the store.

Collected user purchase data stored in a database is compared to the data of available settlements stored in the same or a distinct database, to identify user purchases that entitle, or likely entitle, the user to make a claim, at 630.

Importantly, here and throughout this specification a purchase that “likely” entitles a user to settlement-damages from a certain settlement is one in which: the user's approximate percent chance of being eligible for the settlement in question, as determined by the service using a certain predictive model, is beyond a predetermined threshold. For example, users with a greater than fifty percent chance of being eligible for a settlement might be considered “likely” eligible.

Further, the predetermined percent threshold may vary depending on the settlement, being lower for settlements with larger potential settlement-damages for the user. For example, a user who had a forty percent chance of being eligible for a settlement which pays eligible class members a minimum of $10,000 in damages, might be determined to “likely” qualify, while a user with a sixty percent chance of being eligible for a settlement which pays $10, might not be considered “likely” to be eligible.

The process to determine the percent probability of a user being eligible for a certain settlement is best explained with an example: it is determined by the service that a user purchased a widget, although the color is not known; a class action settlement is available for purchasers of a blue widget; an analysis of data the service has collected on a subset of users (although a different group could be used) who also purchased a widget, reveals that 50% purchased a widget that was blue. The user, then, might be given a 50% probability of qualifying for the settlement.

In more complicated cases where there are multiple criteria, the co-variance of the criteria are considered in the calculation.

Similarly, the service may determine that a user likely made a certain purchase based on past purchases of the user. For example, a user who purchased an iPhone™ case and an iPhone™ screen protector might be determined to have a 90% probability of having purchased an iPhone™, based on the purchasing habits of another group.

The model or models to determine likely user purchases may be created by the service, by a third-party source, or by a collaboration between the service and a third party.

Data regarding available settlements may be collected by the service or by a third party, from websites, data providers, court records (using Public Access to Court Electronic Records(PACER) public access service, for example), or any other source of class action settlement information.

Web crawling, screen scraping, push notifications, and setting news alerts for keywords related to class-action-settlements may be used to gather information from these and other sources. Settlement Administrators, courts, or court systems, may be recruited to alert the service of new settlements, or to provide settlement information upon receiving it, and a portal or repository may be created to facilitate such communication.

Importantly, included within the scope of the invention is the identification of purchases that entitle the purchaser to settlement-damages by virtue of containing a certain component that is eligible for settlement-damages, or being purchased under a circumstance for which settlement-damages are being paid, even if the purchased item or service per se is not eligible for settlement-damages. For example, a settlement involving a hard-drive manufacturer who sold faulty hard-drives, might provide settlement-damages to anyone who purchased a certain kind of computer known to contain a hard-drive of the manufacturer.

Many settlements require an eligible phone or fax number to qualify and not a purchase (hereinafter, “solicitation settlements”). Usually such settlements are related to a company disregarding a “do not call” list or fax blasting. Solicitation settlements do not publish a list of phone numbers that entitle an individual to settlement-damages, and require potential claimants to plug in their phone or fax number on the settlement website, to be checked against the list of qualifying numbers. Unless the service possesses a list of the eligible phone or fax numbers in a solicitation settlement, the service determines user eligibility by similarly entering in the fax and phone numbers provided by users upon enrollment.

Additionally, because it may be the case that the Settlement Administrator in solicitation settlements does not have a complete list of affected phone or fax numbers (e.g., because the settling company did not provide a full list to the court), user accounts related to phone and fax numbers may be accessed and data collected. Such accounts may be those with network operators (also called: cellular companies, wireless service providers, wireless carriers, mobile network carriers, and carriers), such as Sprint™, Verizon™, AT&T™, or may be virtual network operators (also called mobile other-licensed operators), such as US Mobile™, RedPocket™ and Tracfone™.

The collected data may include, but is not limited to: phone numbers; fax numbers; caller ID or other caller identification; duration of calls; the text of text messages; duration of voicemails; content of voicemails; and the date and time of calls, text messages, and voicemails.

The service may determine, by evaluating news events and litigation, that a product or service currently available for purchase is likely to qualify a purchaser for settlement-damages in the future. For example, a published investigation which found a reputable car maker cheated on emissions standards, might strongly suggest an imminent class-action-lawsuit against the car maker and a subsequent settlement deal.

The service may collect the name of the user's present employer, the names of one or more past employers, as well as the user's job titles while at the collected employers. Of note, multiple job titles may be associated with one employer, in the case of a promotion, for example.

Details on a user's past and present employment are used to determine eligibility for settlements, such as settlements related to insufficient overtime pay or failure to provide required benefits.

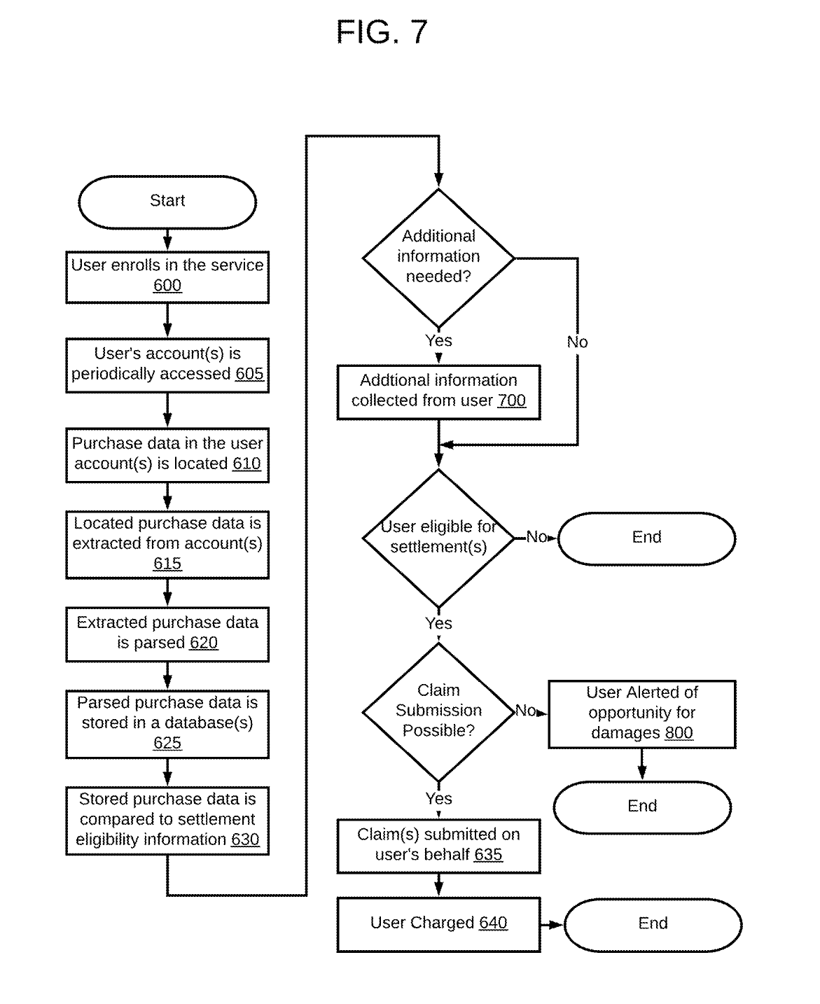

In some embodiments, in cases in which the service requires additional information to determine user eligibility for a settlement, or to complete a claim on behalf of a user, additional information is collected from the user. FIG. 7 is a flowchart of such an embodiment, with additional information being collected from the user at 700.

To collected user information, the user may be contacted through any suitable means of communication (e.g., phone, text message, email) and asked to provide the additional information.

A user who is determined by the service to likely be eligible for settlement-damages may be asked to provide not only the information necessary to determine eligibility, but also information needed to complete the damages-claim, assuming they are in fact eligible, in the same communication.

Moreover, when it is determined that a user qualifies for a settlement, additional information may be collected to complete the settlement-claim, which may require additional specifics that are not disqualifying.

Plainly, because the information to determine eligibility and to complete a damages-claim are often identical, the service may collect both simultaneously.

Individuals may be used to make eligibility determinations when purchase information is contained in a picture and cannot be easily understood by the computer. Freelancing websites (e.g., Mechanical Turk™, Freelancer™, Upwork™), may be used to source people to perform this task.

In embodiments in which a POA is not collected from the user upon enrollment, the service may collect one from a user upon determining that a user is eligible for a settlement for which a signature on the settlement-claim form is required.

Upon collecting all information and legal authority necessary to submit a settlement-claim for a user, the service completes and submits the damages-claim to the relevant Settlement Administrator at 635.

Many claims for settlement damages allow for electronic signing of the one or more forms of the claim, an “electronic signature” hereinafter being any form of computer implemented signature including but not limited to: clicking a signature button, typing a name or initial in a signature field, drawing a signature using a mouse or touchscreen in a signature box, and uploading a signature image of a handwritten signature.

In cases in which a claim for settlement-damages requires a signature on one or more forms, and an electronic signature is allowed, the one or more forms are electronically signed by the attorney-in-fact or on of the attorneys-in-fact of the user and then submitted.

In cases in which a claim for settlement-damages requires a physical signature on one or more forms, the one or more forms are printed out and signed by the attorney-in-fact, or one of the attorneys-in-fact of the user, scanned back onto the computer (or otherwise uploaded), and then submitted.

Settlement damages-claims that do not require a signature of any kind are submitted without a signature.

In some embodiments, the scope of the service is limited to handling one of the above cases (e.g., just cases not requiring a signature), while in others, the scope is limited to performing two of the above cases (e.g., cases not requiring a signature and cases require an electronic signature).

As noted in in the description of FIG. 1, claims may be submitted through the relevant-settlement website, via a mail delivery service (e.g. United States Postal Service™, UPS™, FedEx™), via email, or by any other allowable means.

Along with a settlement-damages claim form, the service may submit one or more Purchase Images, in cases in which doing so is required or helpful. The service may also submit supplementary materials, at the same or a different time, such as a POA document, an appeal requesting re-examination of a claim or additional settlement-damages, a letter explaining the function of the service, a request for additional updates on the status of the claim, a request that settlement-damages be provided via a certain payment method (e.g., check, credit card refund, bank deposit), and a request that a specific portion of the settlement-damages be sent to the service and the other portion sent to the user.

Services that print and mail documents (e.g., LetterStream™, Click2Mail™) may be used to submit damages-claims in cases in which electronic submission is not available, or in which electronic submission is deemed less advantageous (e.g. because the Settlement Administrator does not provide functionality to submit supplementary materials via their website and email is not an option).

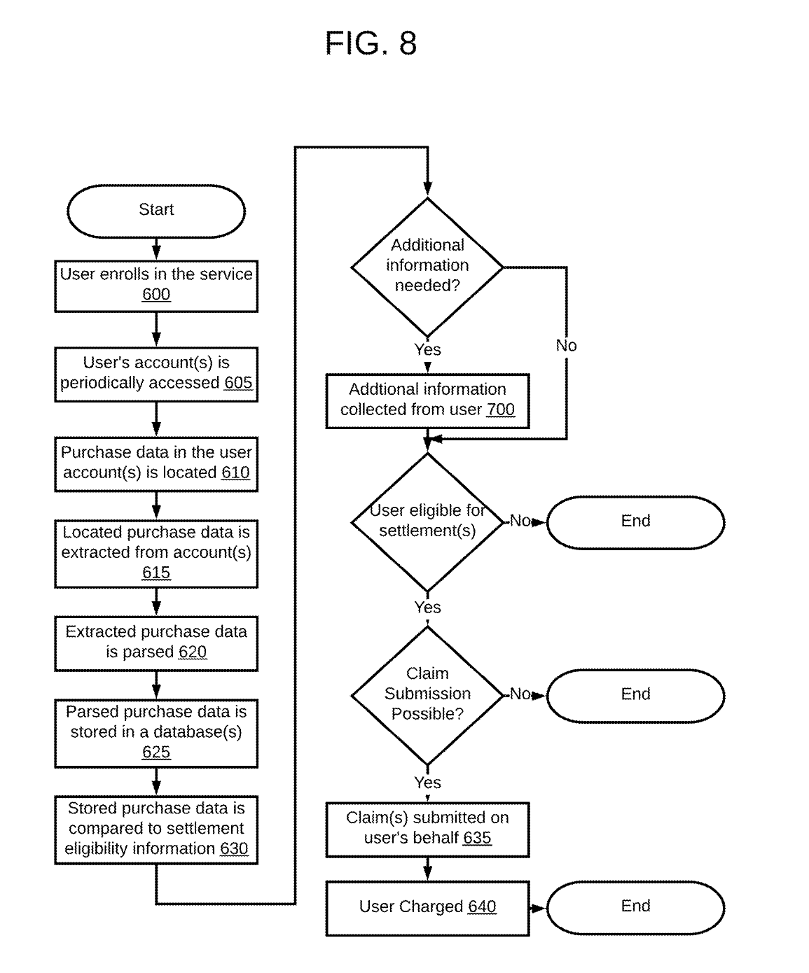

FIG. 8 is a flowchart of an alternate embodiment. In this embodiment, in cases in which it is determined that a user is eligible for settlement-damages from a certain settlement, but the service is unable to submit a claim on the user's behalf (e.g., because of laws in the relevant jurisdiction), the user is alerted of her eligibility through any suitable means of communication, at 800. Upon alerting the user, the service may provide the URL of the Settlement Administrator's website, the URL of the claim form, a claim form either wholly or partially completed with the user's information, a Purchase Image to substantiate the claim, or any additional information which may assist the user in submitting a claim, hereinafter, collectively, “Submission Resources.”

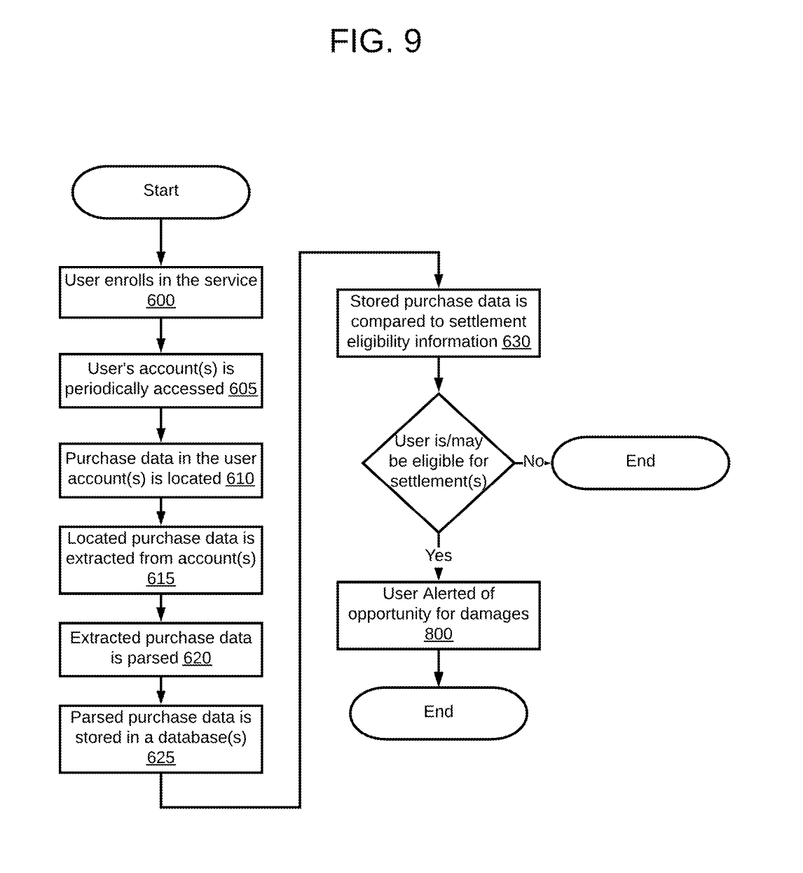

In some embodiments, the scope of the service does not include submitting claims on behalf of users, and users are alerted of their certain or likely eligibility for settlement-damages in the manner described above. FIG. 9 is a flowchart of such an embodiment.

When the service cannot determine a user's eligibility for a certain settlement, and cannot submit claims for the certain settlement on the user's behalf, the service may concurrently, alert the user of the additional information required to determine eligibility, and provide the user with Submission Resources to help them submit a claim in the event they are eligible.

The service may communicate additional information to the user at any time, which may include, but is not limited to: new information related to a settlement; the status or likely status of the claim; the date or date range in which settlement-damages are likely to be issued to the user; the form the settlement-damages will take (e.g., cash, store credit, coupons); the method by which the settlement-damages will be distributed (e.g., mailed check, electronic coupon sent to user email account); and products or services that a user is advised to purchase because of their potential to entitle the user to settlement-damages in the future.

In cases in which the submission of the claim by the service is successful, the user is charged a percentage of the value of the settlement-damages at 640. When settlement-damages are store gift cards, coupons, rebates, or any other form of compensation that is not cash, the service may charge the user a portion of an estimated value of the settlement-damages. Moreover, the service may offer to purchase settlement-damages issued to the user that are not in the form of cash, from the user directly. Such non-cash-settlement-damages may be sold individually or bundled and sold, by the service.

The user may be charged at the expiration of a predetermined period of time following the Settlement Administrator having specified the settlement-damages would be paid, at the time it can be confirmed that a user received the settlement-damages, or at some other time.

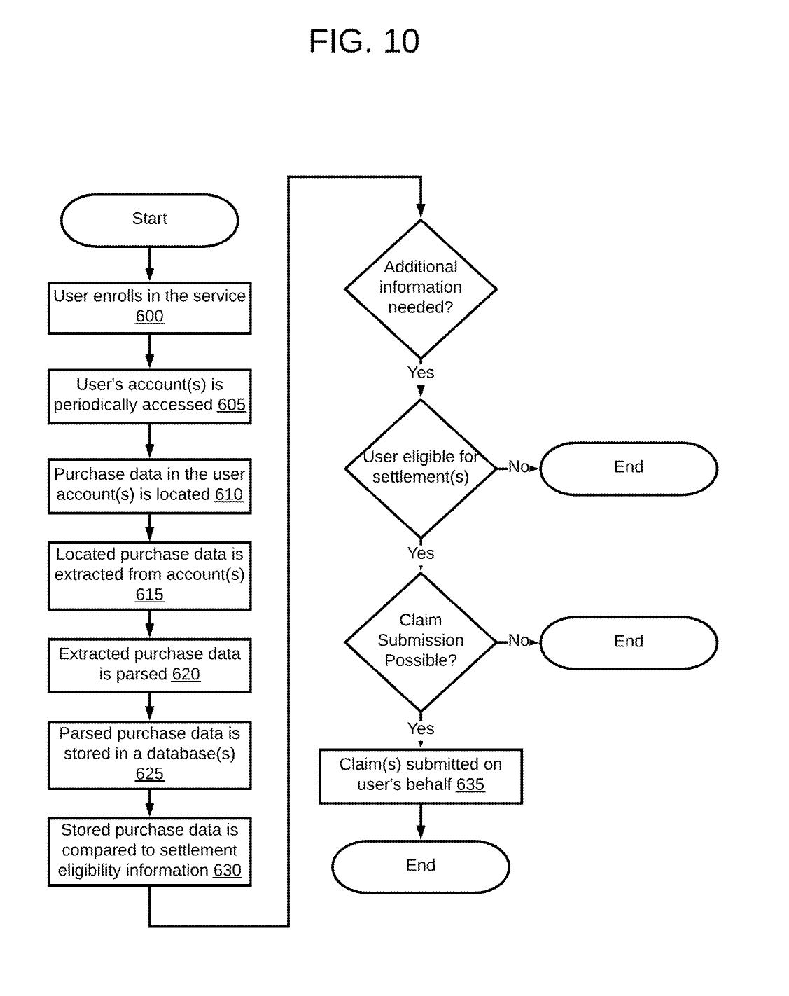

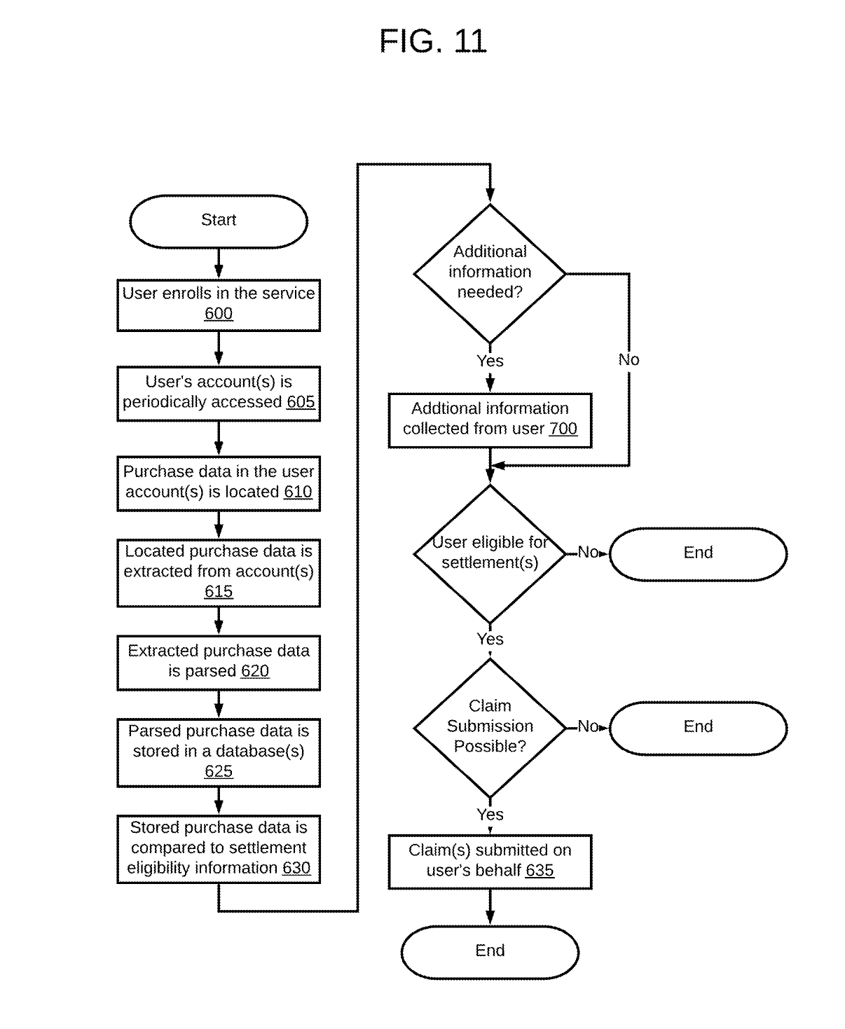

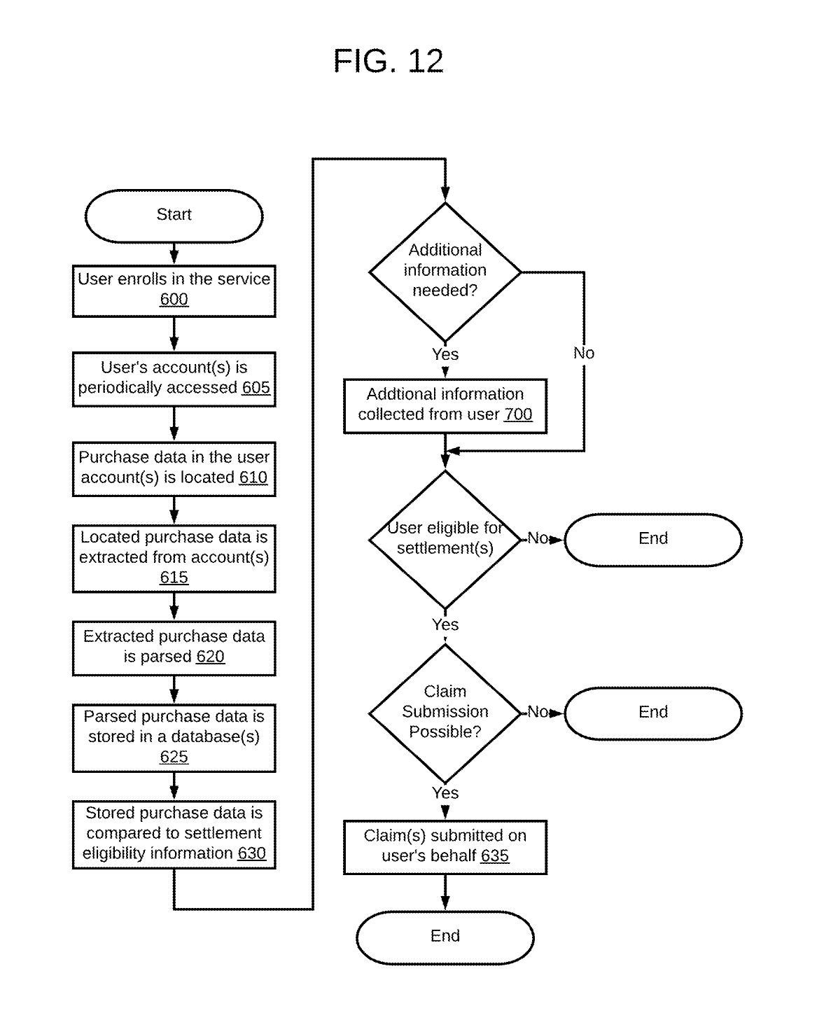

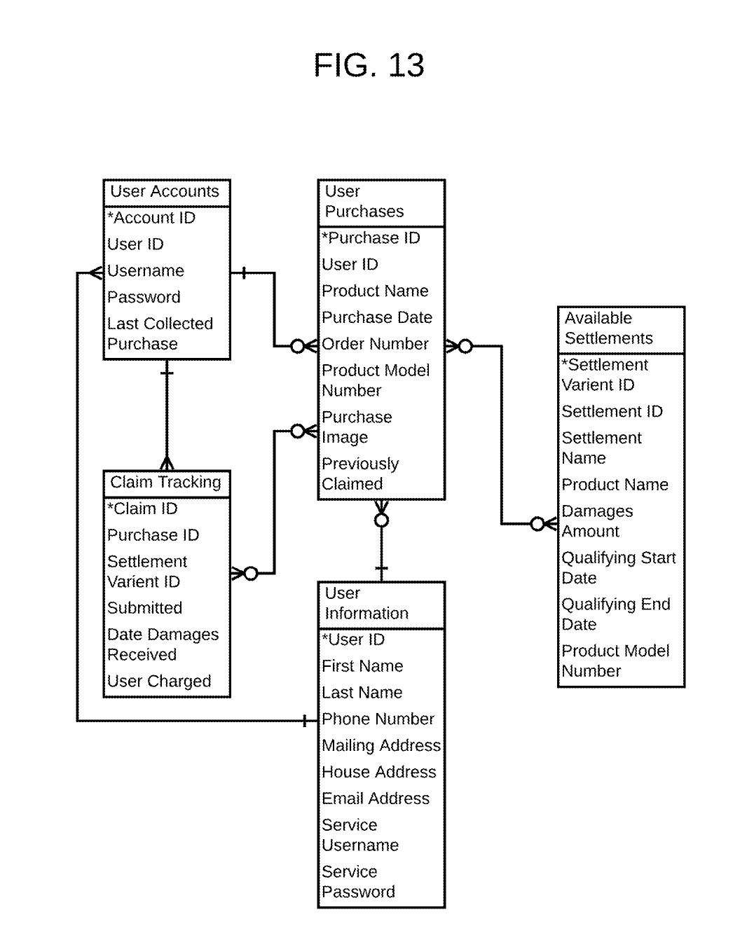

In some embodiments, most likely to be ones in which the service is incorporated into an existing entity, as detailed in figure FIG. 3, the functionality of the service may be provided to the customer of the entity free of charge. FIGS. 9, 10, 11, 12 depict some such embodiments.

Alternatively, the cost of the service may be added to the costs for the goods or services of the entity and not distinctly listed on the bill as a separate charge. For example, the monthly fee to maintain a bank account at a certain bank might be $25, the $25 including the fee for the service but listed on a customer's bill simply as “account maintenance fee: $25.”

In some embodiments, it is verified that the user received or will receive settlement-damages as a result of a claim submitted by the service, by identifying an email in the user's email account from the Settlement Administrator that specifies that settlement-damages have been or will be issued to the user. Similarly, the amount of settlement-damages that have been or will be paid to the user may be established from Settlement Administrator emails.

In some other embodiments, a deposit in the user account from a routing number known to be that of a certain Settlement Administrator, may be used to verify a claim submission, user receipt of settlement-damages, or to determine the amount of the settlement-damages awarded to a user. A deposit for an expected amount in the user account may also be used to verify submission or receipt of settlement-damages. For example, if a Settlement Administrator specified that a class member with the specific circumstances of the user would receive $20.26 in settlement-damages, a deposit for exactly that amount would strongly suggest that the user had received the settlement-damages, even if the routing number was not recognized.

In still other embodiments, the service may direct, on the user's behalf, the Settlement Administrator to provide a portion of the user's settlement-damages directly to the service.

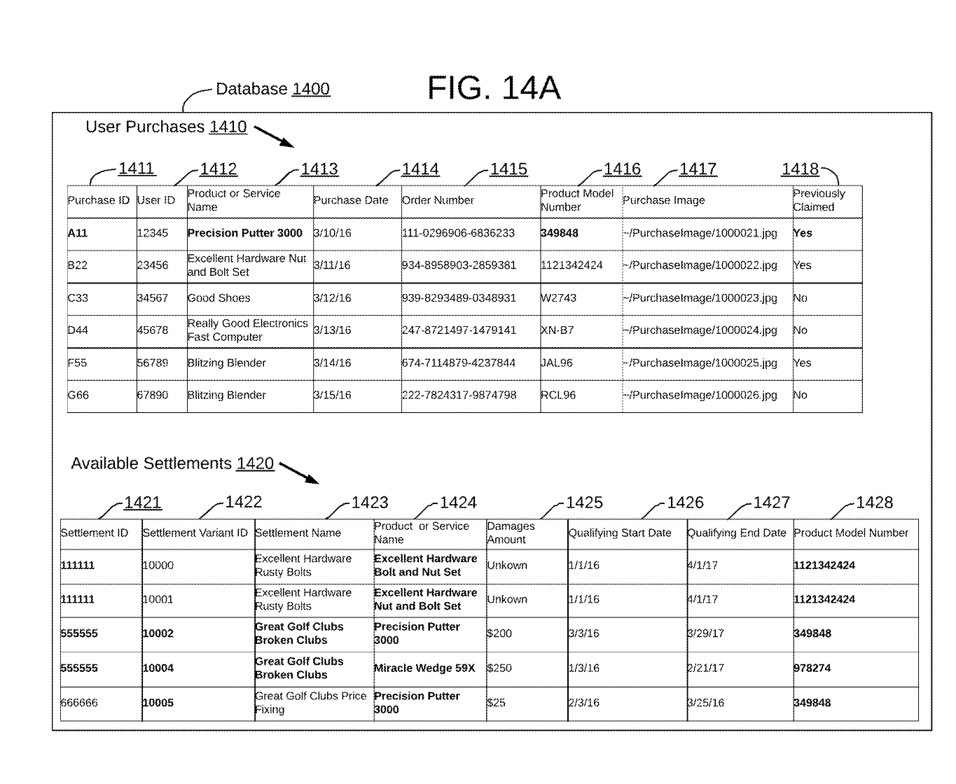

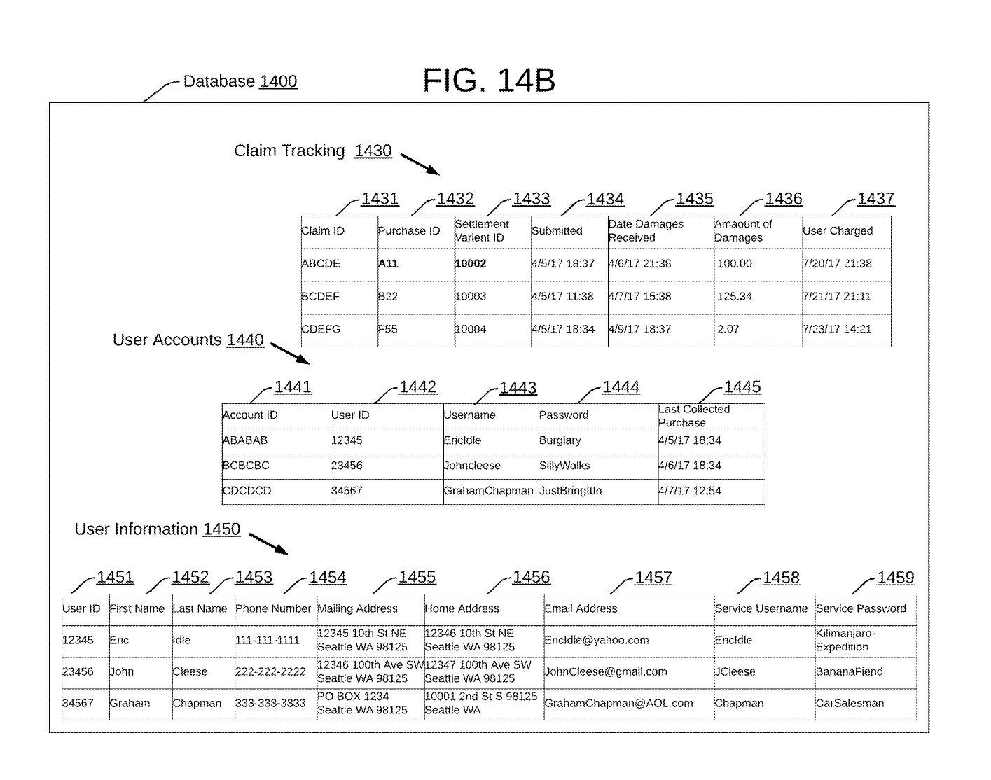

Database 1400 portrayed in FIGS. 14A and 14B is a single example of a database used in one embodiment of the service, simplified to demonstrate core functionality, populated with non-limiting example data, the embodiment being one in which: user purchase data from an Amazon.com™ account of a user is periodically accessed and referenced with compensatory settlement damages eligibility information, to determine that an individual enrolled in the service is entitled to or is likely entitled to one or more damages; in cases in which the service can identify all the information necessary to both determine that a user is eligible for damages and complete the corresponding damages claim, the damages claim is submitted on behalf of the user; the user is charged a fee. Attribute values in FIGS. 14A and 14B that are given special mention in this document are displayed in bold-face font to assist readers of this document, not for any other purpose. Database 1400 is simplified for illustration purposes; in a real-world relational database, for example, a user's name would likely be subdivided into a new table with a First Name, Last Name, Prefix, Suffix, and Accreditation, to handle titles like “Mrs. Jane Doe Jr. PhD,” not just First Name and Last Name as is presented here for clarity. Home Address, Mailing Address, and other attributes of database 1400 may be subdivided as well. Database 1400 could be used as a general template for a database (a “Logical Database Model”), therefore.

Referring to FIG. 14A: database 1400 includes User Purchase table 1410 with the following attributes: a unique ID for each individual purchased product or service 1411; a unique ID assigned to each user upon enrollment in the service 1412; a name of the product or service 1413; the date the purchase was made 1414; an order number of the purchase 1415; a model number 1416; a file path to a Purchase Image stored on the local server 1417; and a Boolean indicating whether the product or service was already claimed by the user or the service one or more times 1418.

Database 1400 also includes Available Settlements table 1420 with the following attributes: a settlement ID uniquely identifying the settlement 1421; a unique settlement variant ID 1422; a name of the settlement 1423; a name of a single product or service for which settlement-damages are available 1424; an amount of settlement-damages available for the single product or service 1425; a first date upon which the purchase of the product or service is eligible for settlement-damages 1426; a last date upon which the purchase of the product or service is eligible for settlement-damages 1427; a product model number 1428.

Referring now to FIG. 14B: database 1400 also includes Claim Tracking table 1430 with the following attributes: a unique ID given to each submitted claim 1431; a unique purchase ID identifying the purchase 1432; a unique settlement variant ID 1433; a submission date 1434; a date it was confirmed that the user should have received settlement-damages 1435; the amount of the settlement-damages received by the user 1436; a date the user was charged 1437.

Database 1400 also includes a User Accounts table 1440 with the following attributes: a unique ID given to each Amazon.com™ account that has been collected from the user to be used by the service 1441; a user ID 1442; a username of the Amazon.com™ account 1443; a password of the Amazon.com™ account 1444; and a last date on which the account was accessed by the service 1445.

Finally, Database 1400 includes a general User Information table 1450 with the following attributes: a unique user ID given to each user 1451; user's first name 1452; a user's last name 1453; a user's phone number 1454; a user's mailing address 1455; a user's home address 1456; a user's email address 1457; a user's username with the service 1458; and a user's password with the service 1459.

The service uses database 1400 as described below:

User Accounts table 1440 is referenced to collect user Amazon.com™ purchase information, and User Purchases table 1410 is updated accordingly. Instances of products or services for which settlement-damages are available in Available Settlements table 1420 are matched with eligible purchases in User Purchases table 1410, and Claim Tracking table 1430 is used to verify that a claim has not yet been submitted for the certain purchase for the certain matched settlement. Claims for eligible purchases are submitted by referencing User Information table 1450. One claim for multiple purchases is submitted in cases where more than one of a single user's purchases qualify for the same settlement, and submitting the purchases collectively is allowed by the Settlement Administrator. The status of submitted claims is tracked using Claim Tracking table 1430, which is updated accordingly with the progress of a claim. After it is determined that the user has received settlement-damages from a certain settlement using Claim Tracking 1430, the user is charged a fee in the amount specified in Available Settlements table 1420.

Database 1400 handles settlements which include more than one product or service, or a single product or service that is sold under more than one name, by assigning an instance to each variation of the name of each product or service in Available Settlements table 1400. To illustrate, notice that, in Available Settlements table 1420, the first instance of “Precision Putter 3000” and “Miracle Wedge 59X” share a Settlement ID and Settlement Name but not a model number, or Settlement Variant ID, representing two distinct products or services subject of a single settlement. Further, notice that the data in Available Settlements table 1420 includes a product named “Excellent Hardware Nut and Bolt Set,” and another named “Excellent Hardware Bolt and Nut Set” (nut and bolt being reversed), but sharing a model number and so representing identical products. Of note, in this case the Excellent Hardware Sets are part of the same settlement, indicated by the shared Settlement ID, although they could be part of separate settlements.

The previously claimed attribute in User Purchases table 1410 is used to ensure that multiple identical claims for a purchase are not submitted for a single settlement, and accounts for the fact that a single purchase may be eligible for settlement-damages from more than one settlement.

Notice that for a purchase with the Purchase ID “All” in User Purchases table 1410, the Previously Claimed attribute is “Yes,” indicting a previous claim for the purchase; the purchase “A11” can be matched with a settlement with a Settlement Variant ID of “10005” listed in Available Settlements 1420, as the Product Service Name and Model Number match, and the date the purchase “A11” was made is after the Qualifying Start date and before the Qualifying End date, together indicating that the purchase is eligible for settlement-damages from a settlement with the Variant ID “10002”; there is an instance in Claim Tracking table 1430 with the same Purchase ID of “A11” and Variant ID of “10002,” indicating that a claim was submitted for purchase “A11” to a settlement with a Settlement Variant ID of “10002.”

Further, notice that the same purchase “A11” can be similarly matched with a settlement with a Variant ID “100005,” but that a claim has not yet been submitted for “A11,” as there is not an instance with both a Purchase ID of “A11” and a Variant ID of “10005” in Claim Tracking table 1430.

Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled.

What is claimed is:

1. A computerized method, comprising:
accessing, by a computing system, user data from a user account;
determining, by the computing system, that a user is a class member of a certain settlement and entitled to certain settlement damages by comparing the user data with relevant settlement damages eligibility information of one or more settlements; and
upon determining that the user is eligible for one or more settlement damages from a settlement, completing and submitting, by the computing system, one or more requisite settlement damages-claims on behalf of the user.

2. The computerized method of claim 1, wherein a user account further comprises: a customer account with a credit card company.

3. The computerized method of claim 1, wherein a user account further comprises: a customer account with a bank.

4. The computerized method of claim 1, wherein a user account further comprises: a customer account with a credit union.

5. The computerized method of claim 1, wherein a user account further comprises: a customer account with a brokerage.

6. The computerized method of claim 1, wherein a user account further comprises: an account with a personal financial management company.

7. The computerized method of claim 1, wherein a user account further comprises: a customer account with a network operator.

8. The computerized method of claim 1, wherein a user account further comprises: a customer account with a virtual network operator.

9. The computerized method of claim 1, wherein a user account further comprises: an account with a payment service, wherein a payment service is any service that facilitates the transfer of funds.

10. The computerized method of claim 1, wherein settlement damages further comprises: compensation not in the form of cash, such as coupons, discounts, vouchers, gift cards, and store cards.

11. The computerized method of claim 1, further comprising: gaining access, by the computer system, to user accounts using the account login credentials of the accounts.

12. The computerized method of claim 1, further comprising: gaining access, by the computer system, to user accounts using reverse engineered application programing interfaces.

13. The computerized method of claim 1, further comprising: gaining access, by the computer system, to one or more user accounts through a privileged account, wherein a privileged account is an account which includes the functionality to access data contained in one or more user accounts.

14. The computerized method of claim 1, wherein user data comprises: transactional records created as a result of one or more purchases having been made by a user.

15. The computerized method of claim 1, wherein user data further comprises: the past location of a user.

16. The computerized method of claim 1, where user data further comprises: a user's call history, text message history, and voicemail history.

17. The computerized method of claim 1, further comprising: the use of screen scraping to extract information on purchases from user accounts and settlement information from settlement websites.

18. The computerized method of claim 1, further comprising: identifying emails from a merchant or service provider based on the sender email address.

19. The computerized method of claim 1, further comprising: soliciting and receiving additional personal details and additional purchase details from a user.

20. The computerized method of claim 1, further comprising: using a predictive model to determine the likelihood that a user made one or more purchases based on the user's purchase history.

21. The computerized method of claim 1, further comprising: wirelessly gathering location data from a user's cellular device, the device being one with location sharing enabled.

22. The computerized method of claim 1, further comprising: acting as a special attorney-in-fact of the user with the authority to submit settlement damages-claims on a user's behalf.

23. The claim of 23, wherein the authority to submit settlement damages-claims on a user's behalf further comprises: the authority to petition Settlement Administrators to re-examine submitted settlement damages-claims that were denied, on a user's behalf.

24. The claim of 23 wherein the authority to submit settlement damages-claims on a user's behalf further comprises: the authority to petition Settlement Administrators for additional settlement damages on a user's behalf.

25. The computerized method of claim 1, further comprising: submitting settlement damages-claims via the relevant settlement website.

26. The computerized method of claim 1, further comprising: submitting settlement damages-claims via an email sent to the relevant email address for submitting claims for a certain settlement.

27. The computerized method of claim 1, further comprising: submitting settlement damages-claims via the United States Postal Service.

28. The computerized method of claim 1, further comprising: submitting settlement damages-claims via a mail delivery service.

29. The computerized method of claim 1, further comprising: submitting, along with a settlement damages-claim, one or more user receipts or images of user purchase information in, to substantiate the claim.

30. The computerized method of claim 1, further comprising: verifying that a user received or will receive settlement damages from the settlement pool of a certain settlement, by identifying an email in the user's email account specifying that settlement damages for the certain settlement were paid or will be paid to the user.

31. The computerized method of claim 1, further comprising: verifying that a user received settlement damages from the settlement pool of a certain settlement by identifying a deposit in the user's bank account made by the Settlement Administrator handling the certain settlement.

32. The computerized method of claim 1, further comprising: charging the user a fee for the service.

33. The claim of 32 wherein the user is charged the fee after the date upon which the Settlement Administrator specified settlement damages would be paid to the user.

34. The claim of 32 wherein the user is charged the fee after the date upon which the Settlement Administrator specified settlement damages would be paid to all or a subset of class members.

35. The claim of 32 wherein the user is charged the fee subsequently to the successful submission of a settlement damages-claim on the behalf of a user.

36. The claim of 32 wherein the user is charged the fee subsequently to confirming that a user received settlement damages related to a specific settlement.

37. The claim of 32 wherein the size of the fee depends on the amount of settlement damages awarded by the Settlement Administrator.

38. The computerized method of claim 1, further comprising: purchasing from a user, settlement damages awarded to the user not taking the form of cash.

39. A computerized method, comprising:
accessing, by a computing system, user purchase data from a user account;
comparing the user purchase data to settlement damages eligibility information of one or more settlements to determine what eligibility criterion are known;
for a certain settlement, assigning a percentage to each criterion composing the eligibility criteria, the percentage being the percentage of individuals in a certain group who met the criterion;
for the certain settlement, using the percentages of each criterion that is not known to be met by a certain user to calculate a final percentage, representing a probability that the certain user is eligible for the certain settlement;
upon the final percentage being at a predetermined level, alerting the user.

40. The computerized method of claim 39, wherein the certain group is comprised of users.

41. The computerized method of claim 39, wherein a user account further comprises: a customer account with a credit card company.

42. The computerized method of claim 39, wherein a user account further comprises: a customer account with a bank.

43. The computerized method of claim 39, wherein a user account further comprises: a customer account with a credit union.

44. The computerized method of claim 39, wherein a user account further comprises: a customer account with a brokerage.

45. The computerized method of claim 39, wherein a user account further comprises: a account with a personal financial management company.

46. The computerized method of claim 39, wherein a user account further comprises: a user payment service account, wherein a payment service is any service that facilitates the transfer of funds.

47. The computerized method of claim 39, further comprising: gaining access, by the computer system, to user accounts using the account login credentials.

48. The computerized method of claim 39, further comprising: gaining access, by the computer system, to user accounts using reverse engineered application programing interfaces.

49. The computerized method of claim 39, further comprising: gaining access, by the computer system, to one or more user accounts through a privileged account, wherein a privileged account is an account which includes the functionality to access data contained in one or more user accounts.

50. The computerized method of claim 39, where alerting the user of the user's eligibility further comprises: providing the user with the URL of the relevant settlement website on which the user can file a settlement damages-claim.

51. The computerized method of claim 39, where alerting the user of the user's eligibility further comprises: providing the user with a one or more of the user's receipts or one or more pictures of the user's purchases, for the user to submit along with one or more settlement damages-claims to substantiate the one or more settlement damages-claims.

52. The computerized method of claim 39, where alerting the user of the user's eligibility further comprises: providing a user with one or more settlement damages-claims, wholly or partially completed with applicable user information.

53. A computer program on a non-transitory computer-readable medium, the program configured to cause at least one processor to execute a method comprising:
accessing, by a computing system, data on purchases from a user account;
determining that a user is a class member of a certain settlement and entitled to certain settlement damages by comparing the purchase data with settlement damages eligibility information of one or more settlements;
upon determining that the user is entitled to one or more settlement damages, completing and submitting, by the computing system, one or more requisite settlement damages claims on behalf of the user.

54. An apparatus comprising:
a computer system;
an interface on the computer system that extracts purchase data for a user on purchases from an account;
a database unit operatively coupled to the computer system that stores relevant information on class-action lawsuits and eligibility data for settlement damages and whether the user is eligible to be a member of a class;
a comparison unit operatively coupled to the computer system that compares the extracted purchase data to eligibility data for which settlement damages are available;
a determination unit in the computing system that determines whether a user is entitled to one or more settlement damages based on results from the comparison unit;
a submission unit in the computer system that, upon determining that the user is entitled to one or more settlement damages, completes and submits one or more settlement damages-claims, on behalf of the user.
